(19) United States
(12) Patent Application Publication
(10) Pub. No.: US 2020/0020243 A1
(43) Pub. Date: Jan. 16, 2020

(54) NO-GROUND TRUTH SHORT ANSWER SCORING

(71) Applicant: INTERNATIONAL BUSINESS MACHINES CORPORATION, Armonk, NY (US)

(72) Inventors: Tengfei MA, White Plains, NY (US); Patrick WATSON, Montrose, NY (US); Jae-Wook AHN, Nanuet, NY (US); Maria CHANG, Irvington, NY (US); Aldis SIPOLINS, New York, NY (US)

(21) Appl. No.: 16/031,062

(22) Filed: Jul. 10, 2018

(51) Int. Cl. G09B 7/02; G06F 17/30; G06N 99/00

(52) U.S. Cl. CPC G09B 7/02; G06N 99/005; G06F 17/30598

(57) ABSTRACT

Systems, methods, and computer-readable media are described for determining a score for a target student answer using unlabeled data. The target answer is provided by a student to a question for which there is no ground-truth answer data. A set of student answers serves as a set of pseudo-reference answers and a classifier is used to score each answer based on each other answer. In this manner, each student answer serves as a pseudo-reference answer for each other student answer. A clustering approach can also be employed to cluster a set of student answers into clusters. The centroids of the clusters can then serve as the set of pseudo-reference answers. Clustering improves the robustness and efficiency of the score determined for a target student answer.

### BACKGROUND

The present invention relates generally to answer scoring, and more particularly, to answer scoring in the absence of reference answers.

Automatically evaluating short-form answers such as student answers to essays or short-answer questions can be a difficult task in the absence of reference answers. Reference answers may not be available due to incomplete data, or in some cases, because a question set does not have a clear, closed set of “correct” answers.

### SUMMARY

In one or more example embodiments, a method for scoring a target answer using unlabeled data is disclosed. The method includes identifying a set of pseudo-reference answers and scoring the set of pseudo-reference answers. The method further includes weighting the set of scored pseudo-reference answers based at least in part on a set of expertise metrics and determining a score for the target answer based at least in part on the weighted set of scored pseudo-reference answers.

In one or more other example embodiments, a system for scoring a target answer using unlabeled data is disclosed. The system includes at least one memory storing computer-executable instructions and at least one processor configured to access the at least one memory and execute the computer-executable instructions to perform a set of operations. The operations include identifying a set of pseudo-reference answers and scoring the set of pseudo-reference answers. The operations further include weighting the set of scored pseudo-reference answers based at least in part on a set of expertise metrics and determining a score for the target answer based at least in part on the weighted set of scored pseudo-reference answers.

In one or more other example embodiments, a computer program product for scoring a target answer using unlabeled data is disclosed. The computer program product includes a non-transitory storage medium readable by a processing circuit, the storage medium storing instructions executable by the processing circuit to cause a method to be performed. The method includes identifying a set of pseudo-reference answers and scoring the set of pseudo-reference answers. The method further includes weighting the set of scored pseudo-reference answers based at least in part on a set of expertise metrics and determining a score for the target answer based at least in part on the weighted set of scored pseudo-reference answers.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic hybrid data flow/block diagram illustrating answer scoring using unlabeled data in accordance with example embodiments.

FIG. 2 is a process flow diagram of an illustrative method for scoring a target answer based at least in part on scores assigned to a set of pseudo-reference answers in accordance with one or more example embodiments.

FIG. 3 is a process flow diagram of an illustrative method for clustering a set of answers to obtain clusters and selecting cluster centers as the set of pseudo-reference answers in accordance with one or more example embodiments.

FIG. 4 is a schematic diagram of an illustrative computing device configured to implement one or more example embodiments.

### DETAILED DESCRIPTION

Example embodiments relate to, among other things, systems, methods, computer-readable media, techniques, and methodologies for determining a score for a target student answer using unlabeled data. In example embodiments, the target answer is provided by a student to a question for which there is no ground-truth answer data. For instance, the question can be an open-ended essay question or an otherwise short-form question that calls for a text-based answer that cannot be labeled as a definitively correct answer.

More specifically, certain example embodiments relate to utilizing a set of student answers as pseudo-reference answers and scoring each answer based on each other answer. In example embodiments, a respective student profile is generated for each student that includes scores assigned to historical answers provided by the student. A student profile can be used to determine an expertise level of a student. A trained classifier may be provided, or in the alternative, a classifier is trained using students answers to prior exams that have been graded (i.e., labeled answers). The trained classifier is then used to score each student answer in a set of student answers based on the score of each other student answer in the set. In this manner, each student answer serves as a pseudo-reference answer for each other student answer. In example embodiments, to determine the score for a target student answer, the score of each other student answer is weighted with a respective expertise metric indicative of the expertise level of a corresponding student, and the weighted scores are summed and normalized over the sum of the expertise metrics.

In other example embodiments, a clustering approach is employed. More specifically, in certain example embodiments, an initial set of pseudo-reference answers are clustered into a set of clusters based at least in part on one or more text-based features. The text-based features include, for example, an extent of word overlap between the initial set of pseudo-reference answers (e.g., a frequency of word overlap, a number of overlapping words, etc.); a semantic similarity between the pseudo-reference answers; and so forth. Once the clusters are obtained, they are compared to an independent measure of student ability to label (e.g., score) the clusters. In example embodiments, the independent measure of student ability are the expertise metrics described earlier. Cluster centers of the clusters are then identified as being representative of the corresponding clusters and a similarity between a target student answer and the cluster centers is determined to score the target student answer.

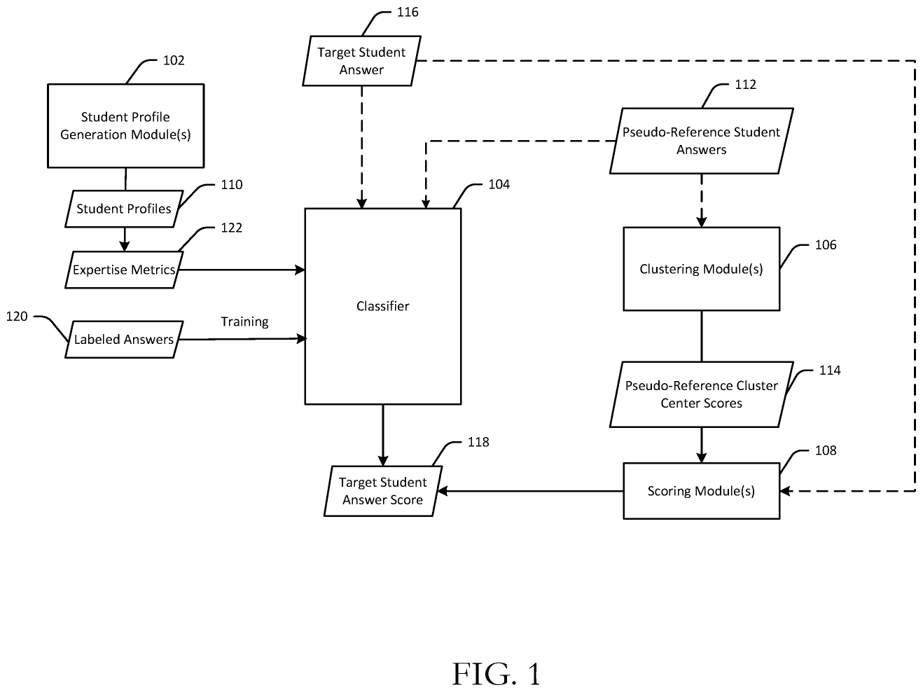

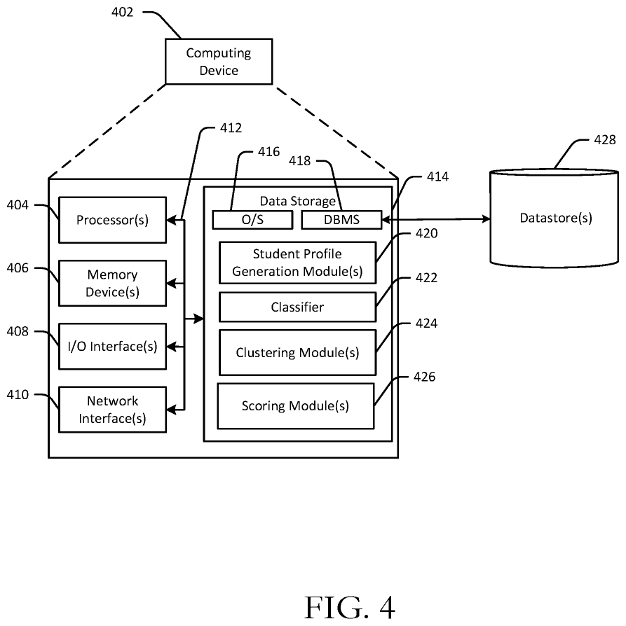

Various illustrative methods and corresponding data structures associated therewith will now be described. It should be noted that each operation of the methods 200-300 may be performed by one or more of the program modules or the like depicted in FIG. 1 or 4, whose operation will be described in more detail hereinafter. These program modules may be implemented in any combination of hardware, software, and/or firmware. In certain example embodiments, one or more of these program modules may be implemented, at least in part, as software and/or firmware modules that include computer-executable instructions that when executed by a processing circuit cause one or more operations to be performed. A system or device described herein as being configured to implement example embodiments may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

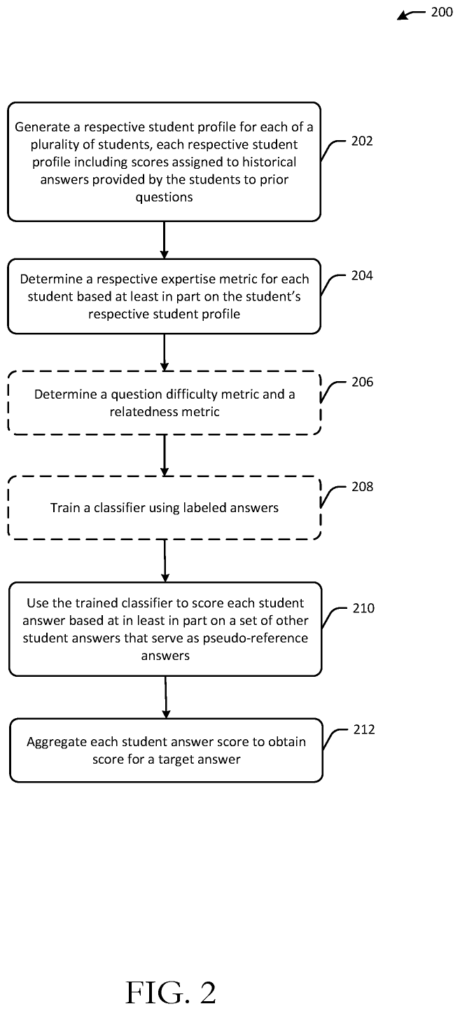

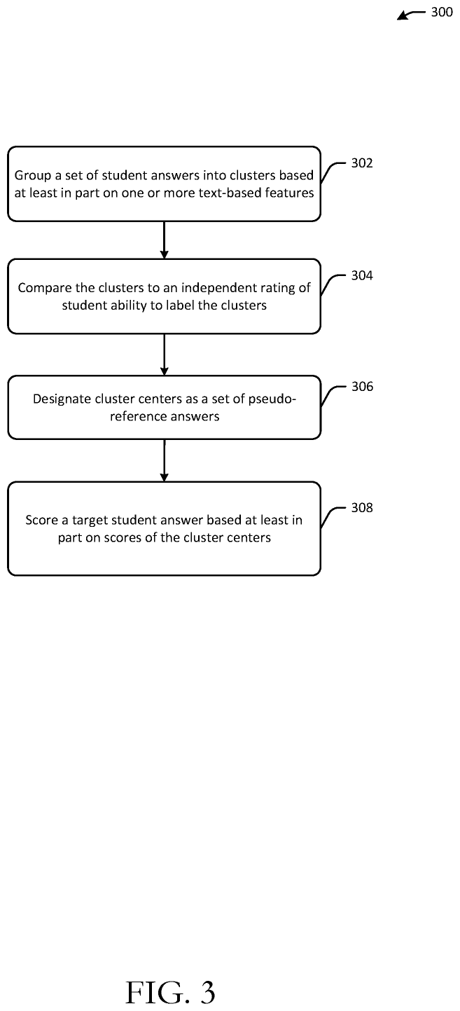

FIG. 1 is a schematic hybrid data flow/block diagram illustrating answer scoring using unlabeled data in accordance with example embodiments. FIG. 2 is a process flow diagram of an illustrative method 200 for scoring a target answer based at least in part on scores assigned to a set of pseudo-reference answers in accordance with one or more example embodiments. FIG. 3 is a process flow diagram of an illustrative method 300 for clustering a set of answers to obtain clusters and selecting cluster centers as the set of pseudo-reference answers in accordance with one or more example embodiments. FIGS. 2 and 3 will each be described hereinafter in conjunction with FIG. 1.

Referring first to FIG. 1 and FIG. 2 in conjunction with one another, at block 202 of the method 200, in accordance with example embodiments, computer-executable instructions of one or more student profile generation modules 102 are executed to generate a set of student profiles 110 for a plurality of students, where each student profile 110 is associated with a corresponding student. Each respective student profile 110 includes scores assigned to historical answers provided by the corresponding student to prior questions.

At block 204 of the method 200, in accordance with example embodiments, computer-executable instructions of the student profile generation module(s) 102 are executed to determine a respective expertise metric 122 for each student based at least in part on the student's respective student profile 110. Each expertise metric 122 is a measure of a corresponding student's answer quality, as determined from historical answers provided by the student and corresponding scores assigned thereto. In example embodiments, each respective student profile 110 includes the corresponding expertise metric of the corresponding student 122.

Then, optionally, at block 206 of the method 200, in accordance with example embodiments, a question difficulty metric and a relatedness metric are determined. The question difficult metric is a measure of the difficulty level of a question. In example embodiments, a relatedness metric is determined for each student answer with respect to the question and provides a measure of the degree to which a student answer is relevant to the subject matter of the question. For instance, assuming we have T students that provide T answers, respectively, the set of student answers is given by A={a₁, . . . , a_{T}). A relatedness metric rᵢ is then determined for each student answer aᵢ with respect to the question, in example embodiments.

At block 208 of the method 200, in accordance with example embodiments, a classifier 104 is optionally trained using labeled student answers 120. More specifically, the scores assigned to historical answers provided by students—as reflected in the set of labeled student answers 120—are used to train the classifier 104. Then, at block 210 of the method 200, the trained classifier 104 is used to score each student answer based at least in part on a set of other student answers that serve as a set of pseudo-reference answers 112. Referring again to the example introduced earlier, the set of pseudo-reference answers 112 is given by A={a₁, . . . , a_{T}). For any given target student answer 116 (e.g., aₙ in the set A), the score of the target student answer 116 is determined using the classifier 104 based at least in part on the scores of each other student answer in the set A (e.g., {s₁, . . . , sₙ₋₁, sₙ₊₁, . . . , s_{T}}). The classifier 104 can utilize any suitable unsupervised machine learning algorithm.

At block 212 of the method 200, each student answer score in the set {s₁, . . . , sₙ₋₁, sₙ₊₁, . . . , s_{T}} is aggregated to obtain a score 118 of the target student answer 116 (e.g., sₙ). More specifically, in example embodiments, each student answer score in the set {s₁, . . . , sₙ₋₁, sₙ₊₁, s_{T}} is multiplied by the expertise metric mᵢ of corresponding student and summed to obtain an aggregate sum. This aggregate sum is then normalized by the sum of the expertise metrics mᵢ for each student to obtain the target student answer score 118. In certain example embodiments, each term sᵢ*mᵢ is also multiplied by the corresponding relatedness metric rᵢ and the question difficulty metric (qd) to obtain a term sᵢ*mᵢ*rᵢ*qd for each student. These terms are then summed across the set {s₁, . . . sₙ₋₁, sₙ₊₁, . . . , s_{T}} and normalized over the sum of the expertise metrics mᵢ to obtain the target student answer score 118 (e.g., the score for aₙ).

In certain example embodiments, a clustering technique is employed to increase the robustness of the target student answer score 118 obtained according to the example method 200 of FIG. 2. Referring now to FIG. 3 in conjunction with FIG. 1, at block 302 of the method 300, computer-executable instructions of one or more clustering modules 106 are executed to cluster the set of pseudo-reference student answers 112 (e.g., the example set A introduced earlier) into a set of clusters based at least in part on one or more text-based features. The text-based features include, for example, an extent of word overlap between the set of pseudo-reference answers 112 (e.g., a frequency of word overlap, a number of overlapping words, etc.); a semantic similarity between the pseudo-reference answers 112; and so forth. The clustering algorithm can be, for example, a K-means clustering algorithm. The number of clusters that are formed can be determined, for example, using a Bayesian non-parametric method such as a Dirichlet Process Gaussian Mixture model to automatically infer the cluster number. In other example embodiments, a cluster distance is predefined and the cluster number is determined from the cluster distance.

At block 304 of the method 300, computer-executable instructions of the clustering module(s) 106 are executed to compare each cluster to an independent measure of student ability to label (e.g., score) the clusters. In example embodiments, the independent measure of student ability is the expertise metric 122 determined from a student profile 110. More specifically, in example embodiments, for a given cluster, a weighted average of the expertise metrics corresponding to students that provided the answers in the cluster is used to score the cluster. In this manner, a set of scores corresponding to the set of clusters is obtained.

At block 306 of the method 300, computer-executable instructions of the clustering module(s) 106 are executed to designate a respective center of each cluster as a pseudo-reference answer to be used to score the target student answer 116. In particular, a set of pseudo-reference cluster center scores 114 are determined by identifying the center of each cluster and assigning the score assigned to the cluster to the cluster center. Utilizing cluster centers as the pseudo-reference student answers allows for some original “noisy” answers to be ignored, and clustering in general makes the scoring system more efficient by decreasing the number of answers used as pseudo-reference answers.

Then, at block 308 of the method 300, computer-executable instructions of one or more scoring modules 108 are executed to obtain the score 118 of the target student answer 116 based at least in part on the set of pseudo-reference cluster center scores 114. In particular, in certain example embodiments, a respective similarity metric is determined between the target student answer 116 and each cluster center, and the set of similarity metrics so determined is used to score the target student answer 116 based on the pseudo-reference cluster center scores 114.

In example embodiments, the labeled clusters are used as an alternative to the historical past performance of students to determine the score of the target student answer 116. However, in certain example embodiments, certain student answers (e.g., certain selected answers in the set A) can be labeled as ground-truth data to improve accuracy of the target student answer score 118.

In other example embodiments, student answers are clustered to define a vector space that represents an entire corpus of all potential student answers. In example embodiments, the vector space can define a “verbose answer” (e.g., everything included in every student response). Each student answer is then scored by applying vector algebra to the entire vector space.

Example embodiments provide various technical features, technical effects, and/or improvements to computer technology. Specifically, example embodiments provide technological improvements to computer-based answer scoring technology by allowing for a short answer/essay question to be scored in the absence of labeled ground-truth data. This technological improvement is enabled by the technical features of training a classifier using historical past performance of students and using the trained classifier to score each student answer based on expertise weighted scores of each other student answer. In this manner, each student answer serves as a pseudo-reference answer for each other student answer. Further, in example embodiments, a clustering approach is used to enhance the robustness (e.g., accuracy of the score determined for a target student answer) and efficiency of the scoring (i.e., reduce the number of pseudo-reference answers that are used).

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

FIG. 4 is a schematic diagram of an illustrative computing device 402 configured to implement one or more example embodiments of the disclosure. The computing device 402 may be any suitable device including, without limitation, a server, a personal computer (PC), a tablet, a smartphone, a wearable device, a voice-enabled device, or the like. While any particular component of the computing device 402 may be described herein in the singular, it should be appreciated that multiple instances of any such component may be provided, and functionality described in connection with a particular component may be distributed across multiple ones of such a component.

Although not depicted in FIG. 5, the computing device 402 may be configured to communicate with one or more other devices, systems, datastores, or the like via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 402 may include one or more processors (processor(s)) 404, one or more memory devices 406 (generically referred to herein as memory 406), one or more input/output (“I/O”) interface(s) 408, one or more network interfaces 410, and data storage 414. The computing device 402 may further include one or more buses 412 that functionally couple various components of the computing device 402.

The bus(es) 412 may include at least one of a system bus, a memory bus, an address bus, or a message bus, and may permit the exchange of information (e.g., data (including computer-executable code), signaling, etc.) between various components of the computing device 402. The bus(es) 412 may include, without limitation, a memory bus or a memory controller, a peripheral bus, an accelerated graphics port, and so forth. The bus(es) 412 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 406 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 406 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 406 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 414 may include removable storage and/or non-removable storage including, but not limited to, magnetic storage, optical disk storage, and/or tape storage. The data storage 414 may provide non-volatile storage of computer-executable instructions and other data. The memory 406 and the data storage 414, removable and/or non-removable, are examples of computer-readable storage media (CRSM) as that term is used herein.

The data storage 414 may store computer-executable code, instructions, or the like that may be loadable into the memory 406 and executable by the processor(s) 404 to cause the processor(s) 404 to perform or initiate various operations. The data storage 414 may additionally store data that may be copied to memory 406 for use by the processor(s) 404 during the execution of the computer-executable instructions. Moreover, output data generated as a result of execution of the computer-executable instructions by the processor(s) 404 may be stored initially in memory 406 and may ultimately be copied to data storage 414 for non-volatile storage.

More specifically, the data storage 414 may store one or more operating systems (O/S) 416; one or more database management systems (DBMS) 418 configured to access the memory 406 and/or one or more external datastores 428; and one or more program modules, applications, engines, managers, computer-executable code, scripts, or the like such as, for example, one or more student profile generation modules 420, a classifier 422, one or more clustering modules 424, and one or more scoring modules 426. Any of the components depicted as being stored in data storage 414 may include any combination of software, firmware, and/or hardware. The software and/or firmware may include computer-executable instructions (e.g., computer-executable program code) that may be loaded into the memory 406 for execution by one or more of the processor(s) 404 to perform any of the operations described earlier in connection with correspondingly named modules.

Although not depicted in FIG. 4, the data storage 414 may further store various types of data utilized by components of the computing device 402 (e.g., data stored in the datastore(s) 428). Any data stored in the data storage 414 may be loaded into the memory 406 for use by the processor(s) 404 in executing computer-executable instructions. In addition, any data stored in the data storage 414 may potentially be stored in the external datastore(s) 428 and may be accessed via the DBMS 418 and loaded in the memory 406 for use by the processor(s) 404 in executing computer-executable instructions.

The processor(s) 404 may be configured to access the memory 406 and execute computer-executable instructions loaded therein. For example, the processor(s) 404 may be configured to execute computer-executable instructions of the various program modules, applications, engines, managers, or the like of the computing device 402 to cause or facilitate various operations to be performed in accordance with one or more embodiments of the disclosure. The processor(s) 404 may include any suitable processing unit capable of accepting data as input, processing the input data in accordance with stored computer-executable instructions, and generating output data. The processor(s) 404 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 404 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 404 may be capable of supporting any of a variety of instruction sets.

Referring now to other illustrative components depicted as being stored in the data storage 414, the O/S 416 may be loaded from the data storage 414 into the memory 406 and may provide an interface between other application software executing on the computing device 402 and hardware resources of the computing device 402. More specifically, the 0/S 416 may include a set of computer-executable instructions for managing hardware resources of the computing device 402 and for providing common services to other application programs. In certain example embodiments, the O/S 416 may include or otherwise control the execution of one or more of the program modules, engines, managers, or the like depicted as being stored in the data storage 414. The O/S 416 may include any operating system now known or which may be developed in the future including, but not limited to, any server operating system, any mainframe operating system, or any other proprietary or non-proprietary operating system.

The DBMS 418 may be loaded into the memory 406 and may support functionality for accessing, retrieving, storing, and/or manipulating data stored in the memory 406, data stored in the data storage 414, and/or data stored in external datastore(s) 428. The DBMS 418 may use any of a variety of database models (e.g., relational model, object model, etc.) and may support any of a variety of query languages. The DBMS 418 may access data represented in one or more data schemas and stored in any suitable data repository. Data stored in the datastore(s) 428 may include, for example, student profiles, pseudo-reference answers, cluster scores, expertise metrics, relatedness metrics, question difficult metrics, and so forth. External datastore(s) 428 that may be accessible by the computing device 402 via the DBMS 418 may include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the computing device 402, the input/output (I/O) interface(s) 408 may facilitate the receipt of input information by the computing device 402 from one or more I/O devices as well as the output of information from the computing device 402 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device 402 or may be separate. The I/O devices may further include, for example, any number of peripheral devices such as data storage devices, printing devices, and so forth.

The I/O interface(s) 408 may also include an interface for an external peripheral device connection such as universal serial bus (USB), FireWire, Thunderbolt, Ethernet port or other connection protocol that may connect to one or more networks. The I/O interface(s) 408 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The computing device 402 may further include one or more network interfaces 410 via which the computing device 402 may communicate with any of a variety of other systems, platforms, networks, devices, and so forth. The network interface(s) 410 may enable communication, for example, with one or more other devices via one or more of the network(s).

It should be appreciated that the program modules/engines depicted in FIG. 4 as being stored in the data storage 414 are merely illustrative and not exhaustive and that processing described as being supported by any particular module may alternatively be distributed across multiple modules, engines, or the like, or performed by a different module, engine, or the like. In addition, various program module(s), script(s), plug-in(s), Application Programming Interface(s) (API(s)), or any other suitable computer-executable code hosted locally on the computing device 402 and/or other computing devices accessible via one or more networks, may be provided to support functionality provided by the modules depicted in FIG. 4 and/or additional or alternate functionality. Further, functionality may be modularized in any suitable manner such that processing described as being performed by a particular module may be performed by a collection of any number of program modules, or functionality described as being supported by any particular module may be supported, at least in part, by another module. In addition, program modules that support the functionality described herein may be executable across any number of cluster members in accordance with any suitable computing model such as, for example, a client-server model, a peer-to-peer model, and so forth. In addition, any of the functionality described as being supported by any of the modules depicted in FIG. 5 may be implemented, at least partially, in hardware and/or firmware across any number of devices.

It should further be appreciated that the computing device 402 may include alternate and/or additional hardware, software, or firmware components beyond those described or depicted without departing from the scope of the disclosure. More particularly, it should be appreciated that software, firmware, or hardware components depicted as forming part of the computing device 402 are merely illustrative and that some components may not be present or additional components may be provided in various embodiments. While various illustrative modules have been depicted and described as software modules stored in data storage 414, it should be appreciated that functionality described as being supported by the modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional program modules and/or engines not depicted may be present and may support at least a portion of the described functionality and/or additional functionality.

One or more operations of any of the methods 200-300 may be performed by a computing device 402 having the illustrative configuration depicted in FIG. 4, or more specifically, by one or more program modules, engines, applications, or the like executable on such a device. It should be appreciated, however, that such operations may be implemented in connection with numerous other device configurations.

The operations described and depicted in the illustrative methods of FIGS. 2 and 3 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2 and 3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for scoring a target answer using unlabeled data, the method comprising:
identifying a set of pseudo-reference answers;
scoring the set of pseudo-reference answers;
weighting the set of scored pseudo-reference answers based at least in part on a set of expertise metrics; and
determining a score for the target answer based at least in part on the weighted set of scored pseudo-reference answers.

2. The computer-implemented method of claim 1, further comprising:
generating a respective student profile for each of a plurality of students, each respective student profile including scores assigned to historical answers provided by a corresponding student; and
determining each expertise metric based at the respective corresponding student profile,
wherein determining the score for the target answer comprises summing the weighted set of scored pseudo-reference answers to obtain a sum and normalizing the sum over a sum of the set of expertise metrics.

3. The computer-implemented method of claim 2, wherein weighting the set of pseudo-reference answers further comprises multiplying each weighted pseudo-reference answer by a question difficulty metric indicative of a difficulty level of a question.

4. The computer-implemented method of claim 2, wherein determining the score for the target answer further comprises:
training a classifier using labeled student answers; and
utilize the trained classifier to score the set of pseudo-references.

5. The computer-implemented method of claim 1, further comprising:
clustering an initial set of pseudo-reference answers into a set of clusters based at least in part on one or more text-based features to obtain a set of clusters;
comparing the set of clusters to the set of expertise metrics to assign a respective label to each cluster in the set of clusters;
designating a set of cluster centers of the set of clusters as the set of pseudo-reference answers.

6. The computer-implemented method of claim 5, wherein the one or more text-based features comprise at least one of word overlap between the initial set of pseudo-reference answers or semantic similarity between the initial set of pseudo-reference answers.

7. The computer-implemented method of claim 1, wherein the target answer is a first target answer, the method further comprising:
clustering the set of pseudo-reference answers into a set of clusters, the set of clusters defining a vector space of all potential answers; and
determining a score for a second target answer at least in part by applying vector algebra to the vector space.

8. A system for scoring a target answer using unlabeled data, the system comprising:
at least one memory storing computer-executable instructions; and
at least one processor of a sending device, wherein the at least one processor is configured to access the at least one memory and execute the computer-executable instructions to:
identify a set of pseudo-reference answers;
score the set of pseudo-reference answers;
weight the set of scored pseudo-reference answers based at least in part on a set of expertise metrics; and
determine a score for the target answer based at least in part on the weighted set of scored pseudo-reference answers.

9. The system of claim 8, wherein the at least one processor is further configured to execute the computer-executable instructions to:
generate a respective student profile for each of a plurality of students, each respective student profile including scores assigned to historical answers provided by a corresponding student; and
determine each expertise metric based at the respective corresponding student profile,
wherein the at least one processor is configured to determine the score for the target answer by executing the computer-executable instructions to sum the weighted set of scored pseudo-reference answers to obtain a sum and normalize the sum over a sum of the set of expertise metrics.

10. The system of claim 9, wherein at least one processor is configured to weight the set of pseudo-reference answers by executing the computer-executable instructions to multiply each weighted pseudo-reference answer by a question difficulty metric indicative of a difficulty level of a question.

11. The system of claim 9, wherein the at least one processor is configured to determine the score for the target answer by executing the computer-executable instructions to:
train a classifier using labeled student answers; and
utilize the trained classifier to score the set of pseudo-references.

12. The system of claim 8, wherein the at least one processor is further configured to execute the computer-executable instructions to:
cluster an initial set of pseudo-reference answers into a set of clusters based at least in part on one or more text-based features to obtain a set of clusters;
compare the set of clusters to the set of expertise metrics to assign a respective label to each cluster in the set of clusters;
designate a set of cluster centers of the set of clusters as the set of pseudo-reference answers.

13. The system of claim 12, wherein the one or more text-based features comprise at least one of word overlap between the initial set of pseudo-reference answers or semantic similarity between the initial set of pseudo-reference answers.

14. The system of claim 8, wherein the target answer is a first target answer, and wherein the at least one processor is further configured to execute the computer-executable instructions to:
cluster the set of pseudo-reference answers into a set of clusters, the set of clusters defining a vector space of all potential answers; and
determine a score for a second target answer at least in part by applying vector algebra to the vector space.

15. A computer program product for a target answer using unlabeled data, the computer program product comprising a storage medium readable by a processing circuit, the storage medium storing instructions executable by the processing circuit to cause a method to be performed, the method comprising:
identifying a set of pseudo-reference answers;
scoring the set of pseudo-reference answers;
weighting the set of scored pseudo-reference answers based at least in part on a set of expertise metrics; and
determining a score for the target answer based at least in part on the weighted set of scored pseudo-reference answers.

16. The computer program product of claim 15, the method further comprising:
generating a respective student profile for each of a plurality of students, each respective student profile including scores assigned to historical answers provided by a corresponding student; and
determining each expertise metric based at the respective corresponding student profile,
wherein determining the score for the target answer comprises summing the weighted set of scored pseudo-reference answers to obtain a sum and normalizing the sum over a sum of the set of expertise metrics.

17. The computer program product of claim 16, wherein weighting the set of pseudo-reference answers further comprises multiplying each weighted pseudo-reference answer by a question difficulty metric indicative of a difficulty level of a question.

18. The computer program product of claim 16, wherein determining the score for the target answer further comprises:
training a classifier using labeled student answers; and
utilize the trained classifier to score the set of pseudo-references.

19. The computer program product of claim 15, the method further comprising:
clustering an initial set of pseudo-reference answers into a set of clusters based at least in part on one or more text-based features to obtain a set of clusters;
comparing the set of clusters to the set of expertise metrics to assign a respective label to each cluster in the set of clusters;
designating a set of cluster centers of the set of clusters as the set of pseudo-reference answers.

20. The computer program product of claim 15, wherein the target answer is a first target answer, the method further comprising:
clustering the set of pseudo-reference answers into a set of clusters, the set of clusters defining a vector space of all potential answers; and
determining a score for a second target answer at least in part by applying vector algebra to the vector space.
